(19) United States
(12) Patent Application Publication
(10) Pub. No.: US 2020/0072611 A1
(43) Pub. Date: Mar. 5, 2020

(54) INFORMATION PROCESSING DEVICE, INFORMATION PROCESSING METHOD, INFORMATION PROCESSING PROGRAM, AND RECORDING MEDIUM

(71) Applicant: SHARP KABUSHIKI KAISHA, Sakai City (JP)

(72) Inventor: YOSHIHISA SEKIGUCHI, Sakai City (JP)

(21) Appl. No.: 16/553,969

(22) Filed: Aug. 28, 2019

Related U.S. Application Data
(60) Provisional application No. 62/726,048, filed on Aug. 31, 2018.

(51) Int. Cl. G01C 21/12; G01C 22/00; A63B 24/00; G01C 21/20

(52) U.S. Cl. CPC G01C 21/12; G01C 21/206; A63B 24/0062; G01C 22/006

(57) ABSTRACT

[Object] To estimate the inclination of a ground on which a user walks.

[Solution] An information processing device (1) includes a bottom determiner (32) that detects a first timing at which an upper body of a user reaches a lowest position while the user is walking, a heel touchdown determiner (33) that detects a second timing at which a heel of the user touches down on a ground, a time difference calculator (34) that computes a difference between the first timing and the second timing, and an inclination estimator (35) that estimates, on the basis of the difference, an angle of inclination of a ground on which the user is walking.

### TECHNICAL FIELD

The present invention relates to dead reckoning (PDR: pedestrian dead reckoning).

### BACKGROUND ART

Conventionally, there has been a technology with which to identify the present position through the use of positional information that is received from a GPS (global positioning system). For example, a portable device such as a smartphone is mounted with a pedestrian navigation application that shows a user the way on the basis of positional information that the portable device receives from a GPS. However, in a case where the user is inside a building, an underground shopping center, or the like, the portable device is unable to receive radio waves from a GPS. In this case, the pedestrian navigation application calculates the present position of the user by dead reckoning. Further, there has been a technology with which to measure not only the present position of the user but also the inclination of a ground on which the user walks.

### CITATION LIST

### Patent Literature

PTL 1: Japanese Unexamined Patent Application Publication No. 2013-255608
PTL 2: Japanese Unexamined Patent Application Publication No. 2015-54010

### SUMMARY OF INVENTION

### Technical Problem

In order to measure the inclination of the ground on which the user walks, the inventions of PTL 1 and PTL 2 calculate a change in altitude by measuring a change in atmospheric pressure with an atmospheric pressure sensor. However, it is considered difficult to carry out a high-precision measurement with an atmospheric pressure sensor. This is due, for example, to a fluctuation in measured values due to the opening and closing of a door of a closed room or a problem in atmospheric pressure due to weather conditions such as a high pressure system and a low pressure system. It is therefore considered impossible to accurately discriminate between an upward slope and a downward slope or accurately measure the inclination of a slope.

An information processing device of the present invention was made in order to solve the problems described above and has as an object to estimate, with a non-conventional method, the inclination of a ground on which a user walks.

### Solution to Problem

(1) An embodiment of the present invention is directed to an information processing device including: a bottom determiner that detects a first timing at which an upper body of a user reaches a lowest position while the user is walking; a heel touchdown determiner that detects a second timing at which a heel of the user touches down on a ground while the user is walking; a time difference calculator that computes a difference between the first timing and the second timing; and an inclination estimator that estimates, on the basis of the difference computed by the time difference calculator, an angle of inclination of a ground on which the user is walking.

(2) Further, an embodiment of the present invention is directed to, in addition to the configuration (1) described above, the information processing device, wherein the inclination estimator estimates the angle of inclination with reference to relationship information indicating a relationship between the difference and the angle of inclination of a ground on which the user walks.
(3) Further, an embodiment of the present invention is directed to, in addition to the configuration (1) or (2) described above, the information processing device, wherein the bottom determiner detects, as the first timing, a timing at which a vertical acceleration of the user reaches its peak.
(4) Further, an embodiment of the present invention is directed to, in addition to the configuration (1), (2), or (3) described above, the information processing device, wherein the heel touchdown determiner detects, as the second timing, a timing at which a horizontal acceleration of the user reaches bottom.
(5) Further, an embodiment of the present invention is directed to, in addition to the configurations (1) to (4) described above, the information processing device, further including a stride estimator that estimates, on the basis of an angle of inclination estimated by the inclination estimator, a length of stride of a user walking on a ground having the angle of inclination.
(6) Further, an embodiment of the present invention is directed to, in addition to the configurations (1) to (5) described above, the information processing device, further including a consumed calorie estimator that estimates, on the basis of an angle of inclination estimated by the inclination estimator, calories consumed by a user walking on a ground having the angle of inclination.
(7) Further, an embodiment of the present invention is directed to an information processing program for causing a computer to function, the information processing program causing the computer to function as the bottom determiner, the heel touchdown determiner, the time difference calculator, and the inclination estimator.
(8) Further, an embodiment of the present invention is directed to a computer-readable recording medium having recorded thereon an information processing program.
(9) Further, an embodiment of the present invention is directed to an information processing method that an information processing device executes, the information processing method including: a bottom determination step of detecting a first timing at which an upper body of a user reaches a lowest position while the user is walking; a heel touchdown determination step of detecting a second timing at which a heel of the user touches down on a ground while the user is walking; a time difference calculation step of computing a difference between the first timing and the second timing; and an inclination estimation step of estimating, on the basis of the difference computed in the time difference calculation step, an angle of inclination of a ground on which the user is walking.

### Advantageous Effects of Invention

An embodiment of the present invention makes it possible to estimate, with a non-conventional method, the inclination of a ground on which a user walks.

### BRIEF DESCRIPTION OF DRAWINGS

FIG. 1 is a diagram showing an example of wearing of an information processing device according to an embodiment of the present invention.

FIG. 2 is a schematic view showing a configuration of the information processing device according to the embodiment of the present invention.

FIG. 3 is a graph showing, in chronological order, results of measurement of accelerations calculated by an absolute axial acceleration calculator.

FIG. 4A is a graph showing, in chronological order, results of measurement of accelerations calculated by the absolute axial acceleration calculator and a graph showing results of measurements carried out when an ordinary user walks on a horizontal ground.

FIG. 4B is a graph showing, in chronological order, results of measurement of accelerations calculated by the absolute axial acceleration calculator and a graph showing results of measurements carried out when an ordinary user walks on an upward slope.

FIG. 4C is a graph showing, in chronological order, results of measurement of accelerations calculated by the absolute axial acceleration calculator and a graph showing results of measurements carried out when an ordinary user walks on a downward slope.

FIG. 5 is a graph for explaining individual parameters.

FIG. 6 is a flow chart showing an example of operation of the information processing device.

FIG. 7 is a schematic view showing a configuration of the information processing device.

FIG. 8 is a graph for explaining stride parameters.

FIG. 9 is a flow chart showing an example of operation of an information processing device according to an embodiment of the present invention.

FIG. 10 is a schematic view showing a configuration of an information processing device according to an embodiment of the present invention.

### DESCRIPTION OF EMBODIMENTS

The following describes embodiments of the present invention in detail.

### Embodiment 1

### [Information Processing Device 1]

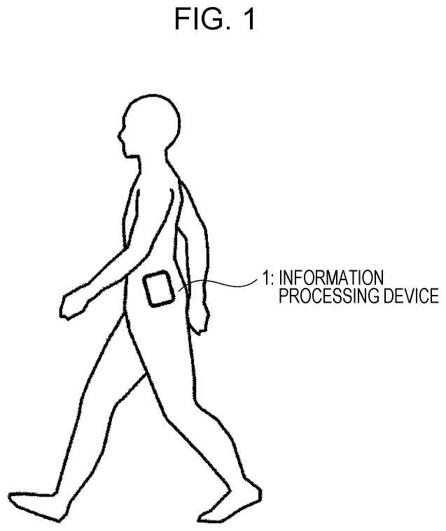

FIG. 1 is a diagram showing an example of wearing of an information processing device 1 according to the present embodiment. Although it is desirable that, as shown in FIG. 1, the information processing device 1 be worn on a position on a user located above the base of a foot of the user, e.g. the waist of the user, the information processing device 1 may be worn on any position, provided it can measure the motion of the upper body of the user. The information processing device 1 measures acceleration in order to estimate the angle of inclination of a ground on which the user walks.

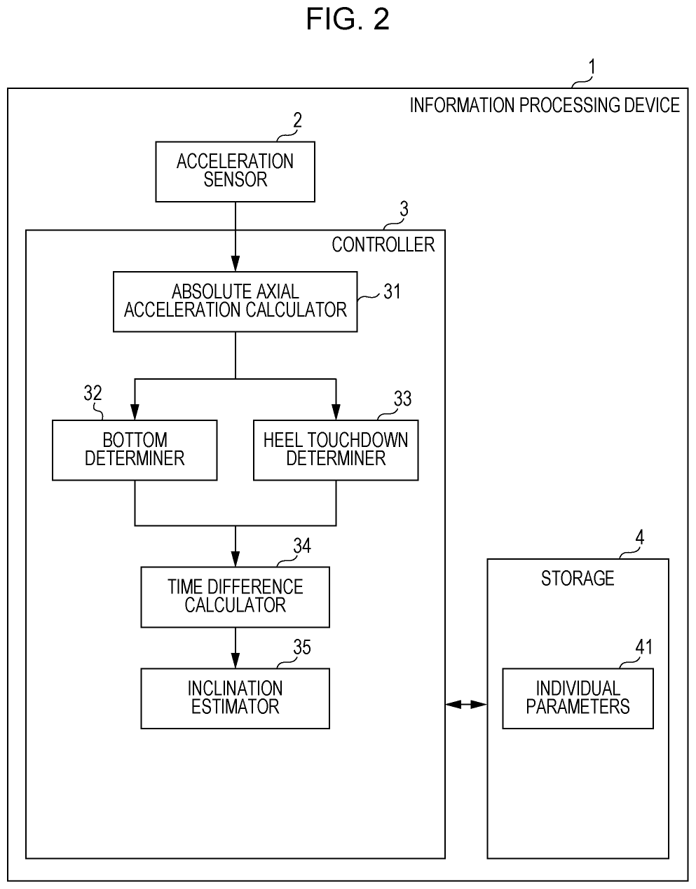

FIG. 2 is a schematic view showing a configuration of the information processing device 1 according to the present embodiment. The information processing device 1 may be incorporated into a portable terminal or the like that acquires positional information, e.g. a smartphone.

The information processing device 1 includes an acceleration sensor 2, a controller 3, and a storage 4. The controller 3 includes an absolute axial acceleration calculator 31, a bottom determiner 32, a heel touchdown determiner 33, a time difference calculator 34, and an inclination estimator 35. The controller 3 may be achieved by a CPU (central processing unit).

Further, although FIG. 2 illustrates the absolute axial acceleration calculator 31, the bottom determiner 32, the heel touchdown determiner 33, the time difference calculator 34, and the inclination estimator 35 as functional blocks that are independent of one another, the absolute axial acceleration calculator 31, the bottom determiner 32, the heel touchdown determiner 33, the time difference calculator 34, and the inclination estimator 35 may be achieved as software of a single MCU (microcontroller unit). Alternatively, the controller 3 may be achieved through the use of hardware such as an FPGA (field-programmable gate array).

[Overall Configuration of Information Processing Device 1]

The acceleration sensor 2 is for example a triaxial acceleration sensor and uses a conventional technology to measure triaxial acceleration along three axial directions, namely an X axis, a Y axis, and a Z axis. The acceleration measured by the acceleration sensor 2 is transmitted to the absolute axial acceleration calculator 31.

The absolute axial acceleration calculator 31 axially transforms the triaxial acceleration detected by the acceleration sensor 2. The axial transformation allows extraction of the vertical and horizontal accelerations of the user. The absolute axial acceleration calculator 31 transmits the vertical acceleration to the bottom determiner 32. Further, the absolute axial acceleration calculator 31 transmits the horizontal acceleration to the heel touchdown determiner 33.

The bottom determiner 32 compares vertical accelerations received at a plurality of timings from the absolute axial acceleration calculator 31 and thereby detects a timing (first timing) at which the user's upper body reaches the lowest position while the user is walking (more strictly, in the cycle of walking movement of the user). In order to detect this first timing, the bottom determiner 32 detects, for example, a timing at which the vertical acceleration reaches its peak. It should be noted that the first timing may be detected in another way. The bottom determiner 32 transmits the first timing to the time difference calculator 34.

From within the horizontal acceleration received from the absolute axial acceleration calculator 31, the heel touchdown determiner 33 detects a timing (second timing) at which the user's heel touches down on the ground while the user is walking (more strictly, in the cycle of walking movement of the user). In order to detect this second timing, for example, the heel touchdown determiner 33 detects a timing at which the horizontal acceleration reaches bottom. It should be noted that the second timing may be detected in another way. The heel touchdown determiner 33 transmits the second timing to the time difference calculator 34.

The time difference calculator 34 calculates the difference between the first timing, detected by the bottom determiner 32, at which the user's upper body reaches the lowest position and the second timing, detected by the heel touchdown determiner 33, at which the user's heel touches down on the ground, and transmits the difference to the inclination estimator 35.

The inclination estimator 35 estimates, with reference to information on the difference between the first timing and the second timing and individual parameters 41 stored in the storage 4, the angle of inclination of the ground on which the user walks (inclination estimation process). The individual parameters 41 are data (relationship information) that indicates a relationship between the difference between the first timing at which the user's upper body reaches the lowest position while the user is walking and the second timing at which the user's heel touches down on the ground while the user is walking and the angle of inclination of the ground on which the user walks.

[Flow of Inclination Estimation Process]

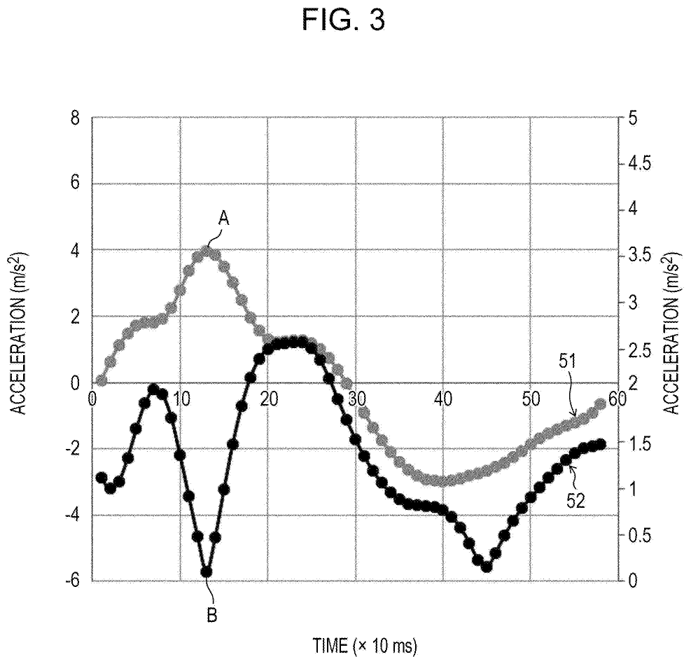

FIG. 3 is a graph showing, in chronological order, results of measurement of accelerations calculated by the absolute axial acceleration calculator 31. On the basis of the results of measurement, the bottom determiner 32 detects a timing (first timing) at which the vertical acceleration reaches its peak. In the example shown in FIG. 3, the sign 51 denotes a line that represents the vertical acceleration, and the timing is represented by a dot A. The magnitude of the vertical acceleration is represented by the left side axis of the graph.

Further, the heel touchdown determiner 33 detects, as a timing (second timing) at which the user's heel touched down on the ground, a timing at which the horizontal acceleration reaches bottom. In the example shown in FIG. 3, the sign 52 denotes a line that represents the horizontal acceleration, and the timing is represented by a dot B. The magnitude of the horizontal acceleration is represented by the right side axis of the graph.

After the heel touchdown determiner 33 has detected the second timing at which the user's heel touched down on the ground, the bottom determiner 32 detects, as the first timing at which the user's upper body reaches the lowest position, a peak of the vertical acceleration detected at a timing closest to the second timing. The cycle of walking movement of the user can be identified by detecting a timing at which the user's heel touched down on the ground first.

Besides the detection method described above, another technique such as a determination of a walking stage by triaxial resultant acceleration or a determination of a relative altitude by a double integral of the vertical acceleration may be used to detect a point at which the vertical acceleration reaches its peak and/or a point at which the horizontal acceleration reaches bottom.

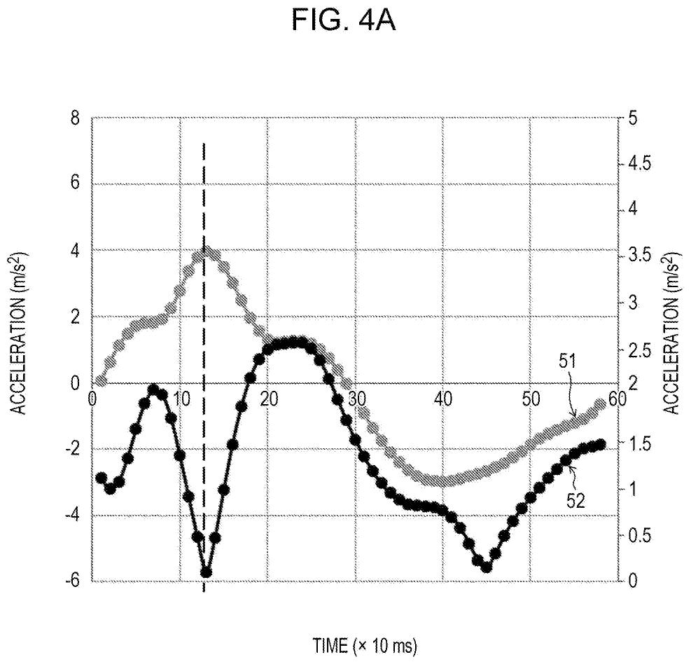

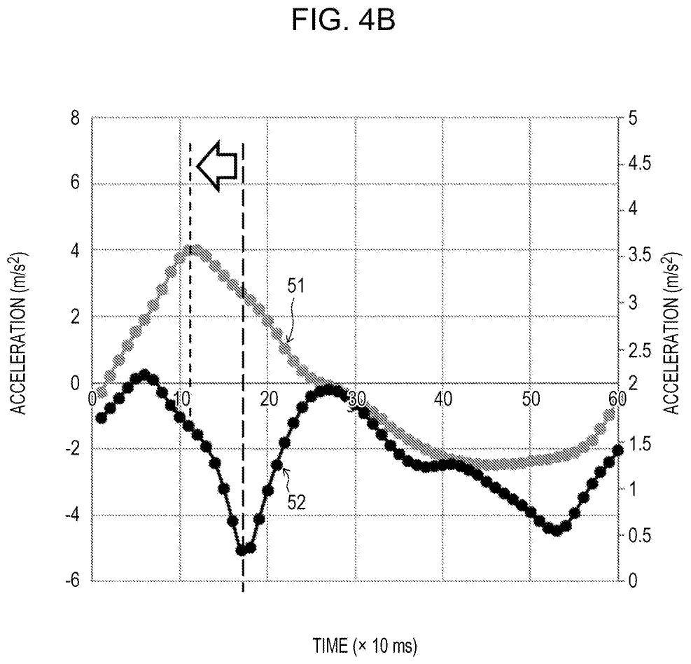

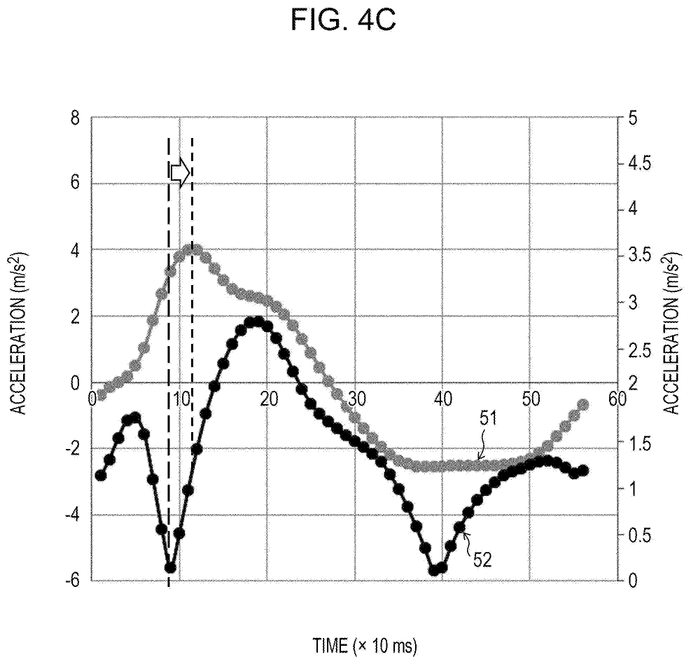

FIG. 4A is a graph showing, in chronological order, results of measurement of accelerations calculated by the absolute axial acceleration calculator 31 when the user walks on a horizontal ground. As illustrated, the peak of the vertical acceleration and the bottom of the horizontal acceleration occur at the same timing. That is, it can be estimated that the heel of a foot that the user had put down touched down on the ground at the same time as the user's upper body reached the lowest position.

In general, when a human walks on a horizontal surface, he/she has his/her feet widest apart when the heel of a foot that he/she has put down touches down on the ground; therefore, it can be estimated that his/her upper body reaches the lowest position at the same timing as the heel of a foot that he/she has put down touches down on the ground. Therefore, in a case where, as shown in FIG. 4A, the timing at which the vertical acceleration reaches its peak and the timing at which the horizontal acceleration reaches bottom are coincident, the inclination estimator 35 estimates that the user is horizontally walking.

FIG. 4B is a graph showing, in chronological order, results of measurement of accelerations calculated by the absolute axial acceleration calculator 31 when the user walks on an upward slope. As illustrated, a comparison between the timing at which the vertical acceleration reaches its peak and the timing at which the horizontal acceleration reaches bottom shows that the timing at which the vertical acceleration reaches its peak is earlier than the timing at which the horizontal acceleration reaches bottom. That is, it can be estimated that the heel of a foot that the user had put down touched down on the ground after the user's upper body had reached the lowest position.

In general, when a human walks on an upward slope, the timing at which his/her upper body reaches the lowest position is earlier than the timing at which the heel of a foot that he/she has put down touches down on the ground, as compared with a case where he/she walks on a horizontal surface. Therefore, in a case where, as shown in FIG. 4B, the timing at which the vertical acceleration reaches its peak is earlier than the timing at which the horizontal acceleration reaches bottom, as compared with the horizontal walking of FIG. 4A, the inclination estimator 35 estimates that the user is walking on an upward slope.

FIG. 4C is a graph showing, in chronological order, results of measurement of accelerations calculated by the absolute axial acceleration calculator 31 when the user walks on a downward slope. As illustrated, a comparison between the timing at which the vertical acceleration reaches its peak and the timing at which the horizontal acceleration reaches bottom shows that the timing at which the horizontal acceleration reaches bottom is earlier than the timing at which the vertical acceleration reaches its peak. That is, it can be estimated that the user's upper body reached the lowest position after the heel of a foot that the user had put down had touched down on the ground. In general, when a human walks on a downward slope, the timing at which the heel of a foot that he/she has put down touches down on the ground is earlier than the timing at which his/her upper body reaches the lowest position, as compared with a case where he/she walks on a horizontal surface. Therefore, in a case where, as shown in FIG. 4C, the timing at which the horizontal acceleration reaches bottom is earlier than the timing at which the vertical acceleration reaches its peal, the inclination estimator 35 estimates that the user is walking on a downward slope.

Although FIGS. 4A to 4C have been described on the premise that when the user walks on a horizontal surface, the user's upper body reaches the lowest position at the same timing as the heel of a foot that the user has put down touches down on the ground, there may be differences among individual users. An example of an individual difference is a case where a user walks on a horizontal surface in such a manner that the heel of a foot that the user has put down touches down on the ground after the user's upper body has reached the lowest position. In the example described above, if the user's upper body has been detected as having reached the lowest position at the same timing as the heel of a foot that the user has put down touches down on the ground, the inclination estimator 35, which will be described later, estimates that the user does not walk on a horizontal surface but walks on a downward slope.

The bottom determiner 32 and the heel touchdown determiner 33 transmit the respective timings thus acquired to the time difference calculator 34.

The time difference calculator 34 calculates the difference between the timing, acquired by the bottom determiner 32, at which the user's upper body reaches the lowest position and the timing, acquired by the heel touchdown determiner 33, at which the user's heel touches down on the ground, and transmits the difference to the inclination estimator 35.

On the basis of the difference between the first timing and the second timing as calculated by the time difference calculator 34, the inclination estimator 35 estimates, with reference to the user's walking information stored as the individual parameters 41, the angle of inclination of the ground on which the user is walking.

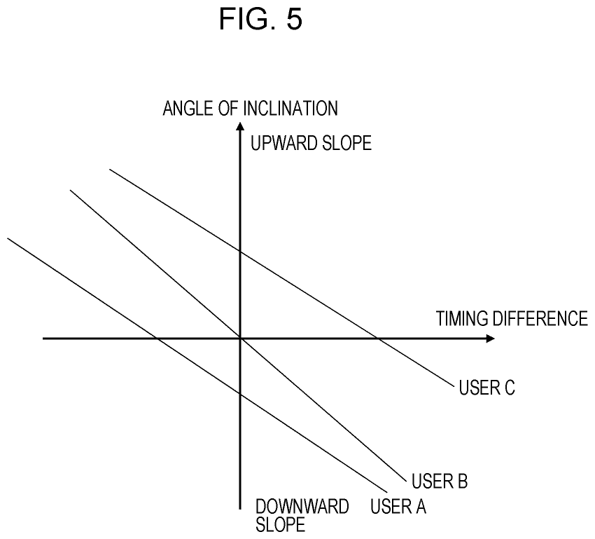

FIG. 5 is a graph for explaining the individual parameters 41. The individual parameters 41 indicate the user's walking information measured in advance. The individual parameters 41 are generated in the following way. First, when a user walks on a ground having a predetermined angle of inclination, the difference between the timing at which the user's upper body reaches the lowest position and the timing at which the user's heel touches down on the ground is acquired. Such a difference is acquired for each of a plurality of angles of inclination. Then, coefficients of transformation from the timing differences thus acquired into angles of inclination are computed, and the coefficients of transformation thus computed are recorded as the individual parameters 41. In FIG. 5, transformations from the differences into angles of inclination are shown in the form of a graph in association with three users (users A, B, and C), respectively. Instead of parameters that vary among individuals, parameters corresponding to the attributes (such as age and sex) of the user may be stored in the storage 4 as alternative parameters to the individual parameters 41.

It should be noted that the origin of the graph shown in FIG. 5 represents a case where the difference between the first timing at which the user's upper body reaches the lowest position and the second timing at which the user's heel touches down on the ground is zero. Further, a domain of the graph in which the difference takes on a positive value represents a case where the first timing was detected later than second timing. Meanwhile, a domain in which the difference takes on a negative value represents a case where the first timing was detected earlier than the second timing.

Alternatively, an estimated angle of inclination of a ground may be set in advance by a table or the like according to the difference between the first timing at which the user's upper body reaches the lowest position and the second timing at which the user's heel touches down on the ground. Such a configuration makes it possible, without including the individual parameters 41, to estimate the angle of inclination of a ground on which a user is walking.

[Example of Operation of Information Processing Device 1]

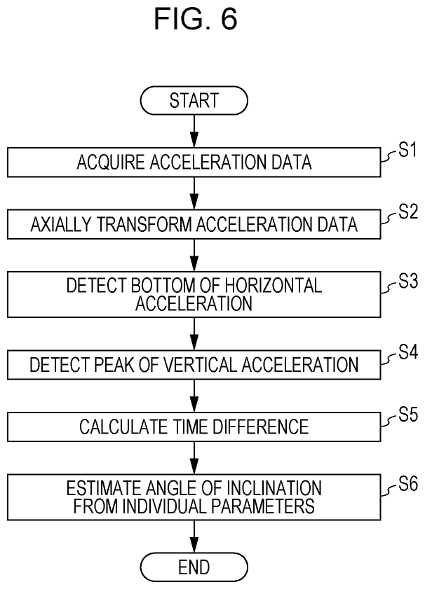

FIG. 6 is a flow chart showing an example of operation of the information processing device 1 according to the present embodiment.

In step S1, the information processing device 1 uses the acceleration sensor 2 to acquire information pertaining to a user's walking. Specifically, the information processing device 1 uses, for example, a triaxial acceleration sensor to measure triaxial acceleration along three axial directions, namely an X axis, a Y axis, and a Z axis. It should be noted that another well-known technology may be used to measure acceleration.

In step S2, the absolute axial acceleration calculator 31 axially transforms the acceleration thus acquired. Specifically, while the triaxial acceleration thus received is along the X, Y, and Z axes, the absolute axial acceleration calculator 31 transforms the triaxial acceleration into a component of horizontal acceleration and a component of vertical acceleration.

In step S3, the heel touchdown determiner 33 detects a second timing at which the horizontal acceleration reaches bottom (heel touchdown determination step).

In step S4, the bottom determiner 32 acquires a first timing at which the vertical acceleration reaches its peak. Specifically, the bottom determiner 32 acquires a first timing detected at a timing closest to the second timing detected in step S3 (bottom determination step).

As mentioned above, as for the flow of processing of steps S3 and S4 described above, another method may be used. Examples include a determination of a walking stage by triaxial resultant acceleration (i.e. a determination as to which walking movement of a series of walking movements is being made) and a method for determining, by a double integral of the vertical acceleration, a relative altitude between a state where the user's upper body reached the lowest position and a state where the user's heel touched down on the ground.

Further, depending on the situation of implementation, the order in which steps S3 and S4 are processed may be changed or steps S3 and S4 may be concurrently processed.

In step S5, the time difference calculator 34 calculates the difference between the second timing, detected in step S3, at which the user's heel touches down on the ground and the first timing, detected in step S4, at which the user's upper body reaches the lowest position (time difference calculation step).

In step S6, the inclination estimator 35 estimates an angle of inclination with reference to the individual parameters 41 stored in the storage 4. Specifically, on the basis of the timing difference calculated in step S5, the inclination estimator 35 estimates, by using the coefficients of transformation stored in advance as the individual parameters 41, the angle of inclination of the ground on which the user is walking (inclination estimation step).

With the configuration described above, the present embodiment makes it possible to estimate the angle of inclination of a ground on which a user walks.

### Embodiment 2

The present embodiment is a technology related to dead reckoning and relates an information processing device 10 that estimates the stride of a user.

[Information Processing Device 10]

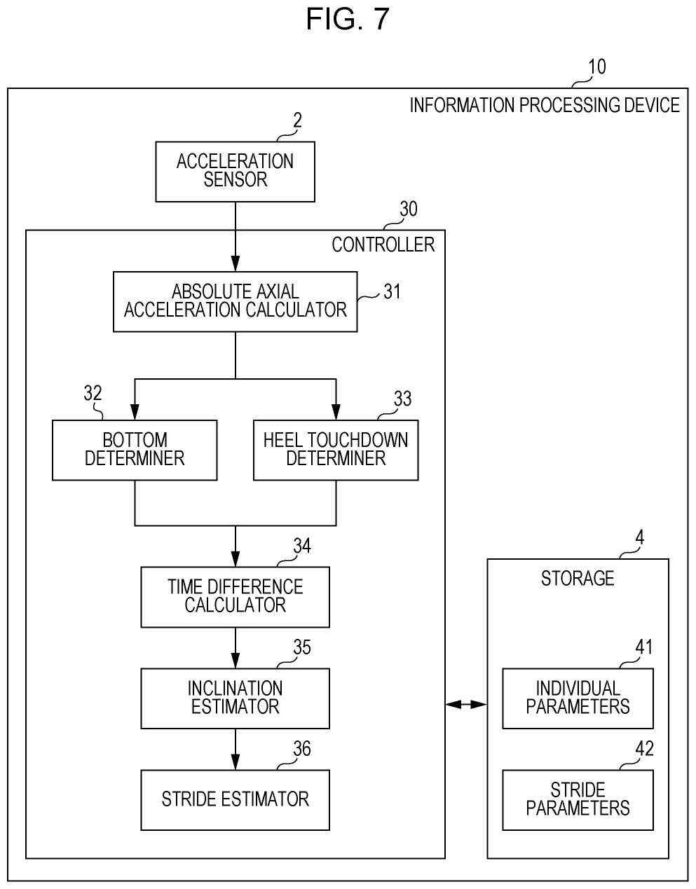

FIG. 7 is a schematic view showing a configuration of the information processing device 10 according to the present embodiment. The information processing device 10 may be incorporated into a portable terminal or the like that acquires positional information, e.g. a smartphone.

The present embodiment estimates the length of stride of a user by focusing attention on the fact that when the user naturally walks on an inclined place, he/she makes shorter strides on an upward slope and makes longer strides on a downward slope than in a case where he/she walks on a horizontal surface.

The information processing device 10 differs from the image processing device 1 of Embodiment 1 in that the information processing device 10 includes a stride estimator 36. It should be noted that components of a controller 30 according to the present embodiment may be achieved, for example, by a CPU (central processing unit), as is the case with Embodiment 1.

Further, although FIG. 7 illustrates the components of the controller 30 as functional blocks that are independent of one another, the components of the controller 30 may be achieved as software of a single MCU (microcontroller unit). Alternatively, the controller 30 may be achieved through the use of hardware such as an FPGA (field-programmable gate array).

[Overall Configuration of Information Processing Device 10]

The following describes an overall configuration of the information processing device 10 according to the present embodiment but omits to describe components which are identical to those of Embodiment 1.

The stride estimator 36 estimates, with reference to information on an angle of inclination received from the inclination estimator 35 and stride parameters 42 stored in the storage 4, the length of stride of a user walking on a ground having the angle of inclination. The stride parameters 42 are data that indicates a relationship (stride information) between the angle of inclination of a ground on which a user walks and the length of stride of the user walking on the ground.

[Flow of Stride Estimation Process]

On the basis of an angle of inclination estimated by the inclination estimator 35, the stride estimator 36 estimates, with reference to a user's stride information indicated by the stride parameters 42, the length of stride of the user walking on a ground having the angle of inclination.

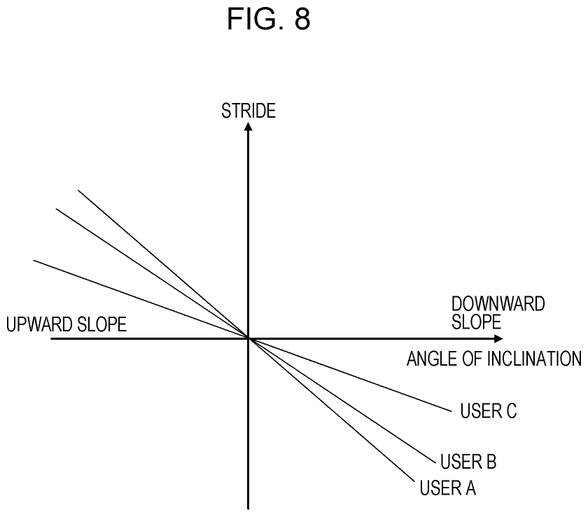

FIG. 8 is a graph for explaining the stride parameters 42. The stride parameters 42 are generated in the following way. When a user walks on a ground having a predetermined angle of inclination, information on the length of stride of the user is acquired. Such information is acquired for each of a plurality of angles of inclination. A conventional technology may be used to acquire the length of stride of a user for each of the plurality of angles of inclination. Then, coefficients of transformation from the angles of inclination into strides are computed on the basis of the information thus acquired on the length of stride of the user, and the coefficients of transformation thus computed are stored as the stride parameters 42 on a user-by-user basis. In FIG. 8, transformations from angles of inclination into strides are shown in the form of a graph in association with three users (users A, B, and C), respectively.

It should be noted that the origin of the graph shown in FIG. 8 indicates an angle of inclination of 0 degree. A positive angle of inclination indicates an upward slope, and a negative angle of inclination indicates a downward slope. The aforementioned means may be replaced by roughly estimating a stride, for example, by configuring in advance a table having stored therein increases and decreases in length of stride that correspond to angles of inclination.

[Example of Operation of Information Processing Device 10]

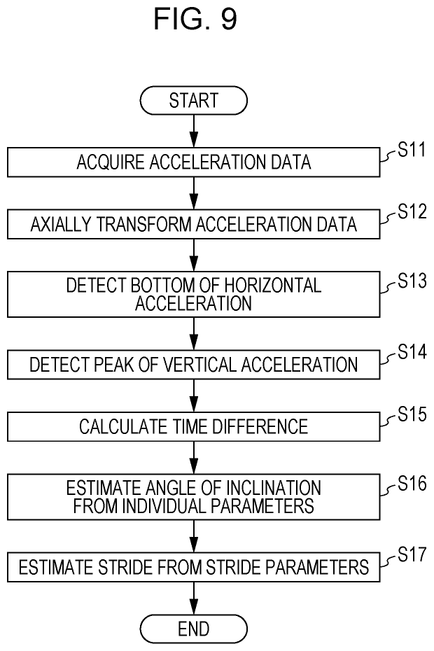

FIG. 9 is a flow chart showing an example of operation of the information processing device 10 according to the present embodiment. It should be noted that a description of steps S11 to S16 is omitted, as they are identical in content to those of Embodiment 1.

In step S17, the stride estimator 36 estimates, with reference to the stride information indicated by the stride parameters 42 stored in the storage 4, the length of stride of the user. Specifically, by applying a coefficient of transformation indicated by the stride parameters 42 to the angle of inclination estimated in step S16, the stride estimator 36 estimates the length of stride of the user walking on a ground having the angle of inclination.

With the configuration described above, the present embodiment makes it possible, for example, to increase the accuracy of an estimate of the present position of a user by estimating the stride of the user.

### Embodiment 3

The present embodiment is a technology related to dead reckoning and relates an information processing device 100 that estimates calories that a user consumes in walking.

[Information Processing Device 100]

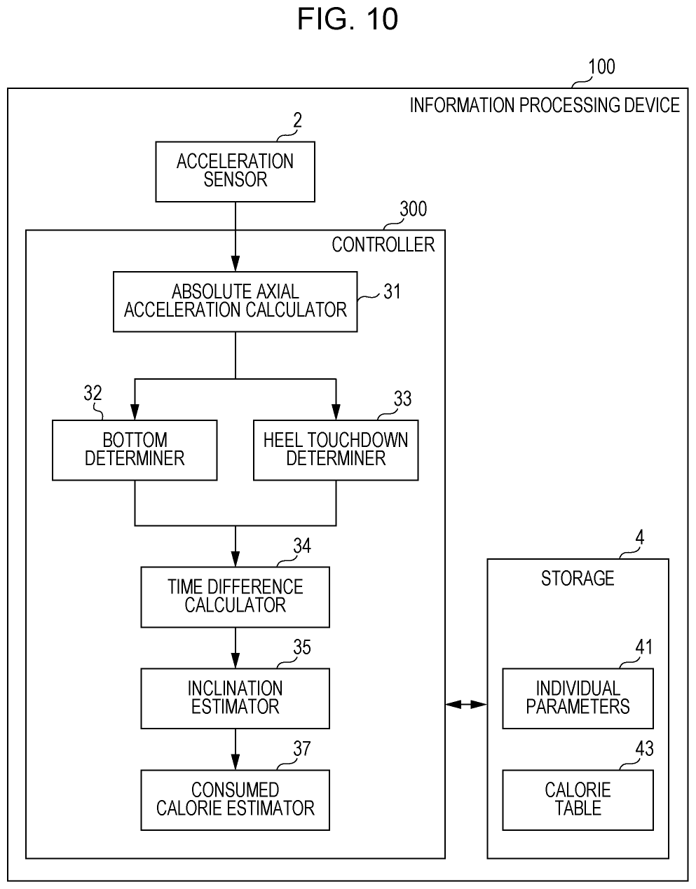

FIG. 10 is a schematic view showing a configuration of the information processing device 100 according to the present embodiment. The information processing device 100 may be incorporated into a portable terminal or the like that acquires positional information, e.g. a smartphone.

The information processing device 100 differs from the image processing devices 1 and 10 of Embodiments 1 and 2 in that the information processing device 100 includes a consumed calorie estimator 37. It should be noted that components of a controller 300 according to the present embodiment may be achieved, for example, by a CPU (central processing unit).

Further, although FIG. 10 illustrates the components of the controller 300 as functional blocks that are independent of one another, the components of the controller 300 may be achieved as software of a single MCU (microcontroller unit). Alternatively, the controller 300 may be achieved through the use of hardware such as an FPGA (field-programmable gate array).

[Overall Configuration of Information Processing Device 100]

The following describes an overall configuration of the information processing device 100 according to the present embodiment but omits to describe components which are identical to those of Embodiment 2.

The consumed calorie estimator 37 estimates, on the basis of an angle of inclination estimated by the inclination estimator 35, calories consumed by the user walking (walking up or down) a ground having the angle of inclination. For example, the consumed calorie estimator 37 estimates, with reference to a calorie table 43 stored in the storage 4, calories consumed by the user. The calorie table 43 is a table that indicates a relationship between the angle of inclination of a ground and calories consumed by the user walking up or down the ground.

[Specific Example of Process of Estimating Consumed Calories]

In a case where the user walks on an upward slope, the consumed calorie estimator 37 sets more calories consumed than in a case where the user walks on a horizontal surface. Further, in a case where the user walks on a downward slope, the consumed calorie estimator 37 sets less calories consumed than in a case where the user walks on a horizontal surface. It should be noted that a degree of increase or decrease in calories consumed may be set according to the difference between the first timing at which the user's upper body reaches the lowest position and the second timing at which the user's heel touches down on the ground.

According to the configuration described above, calories consumed are estimated on the basis of an angle of inclination at which a user walks. This makes it possible to more accurately estimate calories consumed by the user.

### Embodiment 4

[Example of Implementation by Software]

The controller 3 (particularly the absolute axial acceleration calculator 31, the bottom determiner 32, the heel touchdown determiner 33, the time difference calculator 34, and the inclination estimator 35) of the information processing device 1 may be achieved by a logic circuit (hardware) formed on an integrated circuit (IC chip) or the like or may be achieved by software through the use of a CPU (central processing unit). Similarly, the controller 30 (particularly the absolute axial acceleration calculator 31, the bottom determiner 32, the heel touchdown determiner 33, the time difference calculator 34, the inclination estimator 35, and the stride estimator 36) of the information processing device 10 may be achieved by a logic circuit (hardware) formed on an integrated circuit (IC chip) or the like or may be achieved by software through the use of a CPU (central processing unit). Similarly, the controller 300 (particularly the absolute axial acceleration calculator 31, the bottom determiner 32, the heel touchdown determiner 33, the time difference calculator 34, the inclination estimator 35, and the consumed calorie estimator 37) of the information processing device 100 may be achieved by a logic circuit (hardware) formed on an integrated circuit (IC chip) or the like or may be achieved by software through the use of a CPU (central processing unit).

In the latter case, the information processing devices 1, 10, and 100 each include a CPU that executes a command of an information processing program that is software by which each function is achieved, a ROM (read-only memory) or storage device (which is referred to as “recording medium”) on which the program and various types of data are computer-readably (or CPU-readably) recorded, and a RAM (random-access memory) onto which the program is unwound. Moreover, the object of the present invention is attained by a computer (or a CPU) reading the program from the recording medium and executing the program. A usable example of the recording medium is a “non-transient tangible medium” such as a tape, a disk, a card, a semiconductor memory, or a programmable logic circuit. Further, the program may be supplied to the computer via a given transmission medium (such as a communication network or a broadcast wave) via which the program can be transmitted. It should be noted that an aspect of the present invention may be achieved in the form of a data signal, embedded in carrier waves, by which the program is embodied by electric transmission.

### REFERENCE SIGNS LIST

1 Information processing device
2 Acceleration sensor
3 Controller
4 Storage
10 Information processing device
30 Controller
31 Absolute axial acceleration calculator
32 Bottom determiner
33 Heel touchdown determiner
34 Time difference calculator
35 Inclination estimator
36 Stride estimator
37 Consumed calorie estimator
41 Individual parameters
42 Stride parameters
43 Calorie table
100 Information processing device
300 Controller

1. An information processing device comprising:
a bottom determiner that detects a first timing at which an upper body of a user reaches a lowest position while the user is walking;
a heel touchdown determiner that detects a second timing at which a heel of the user touches down on a ground while the user is walking;
a time difference calculator that computes a difference between the first timing and the second timing; and
an inclination estimator that estimates, on the basis of the difference computed by the time difference calculator, an angle of inclination of a ground on which the user is walking.

2. The information processing device according to claim 1, wherein the inclination estimator estimates the angle of inclination with reference to relationship information indicating a relationship between the difference and the angle of inclination of a ground on which the user walks.

3. The information processing device according to claim 1, wherein the bottom determiner detects, as the first timing, a timing at which a vertical acceleration of the user reaches its peak.

4. The information processing device according to claim 1, wherein the heel touchdown determiner detects, as the second timing, a timing at which a horizontal acceleration of the user reaches bottom.

5. The information processing device according to claim 1, further comprising a stride estimator that estimates, on the basis of an angle of inclination estimated by the inclination estimator, a length of stride of a user walking on a ground having the angle of inclination.

6. The information processing device according to claim 1, further comprising a consumed calorie estimator that estimates, on the basis of an angle of inclination estimated by the inclination estimator, calories consumed by a user walking on a ground having the angle of inclination.

7. A computer-readable recording medium having recorded thereon an information processing program for causing a computer to function as the information processing device according to claim 1,
the information processing program causing the computer to function as the bottom determiner, the heel touchdown determiner, the time difference calculator, and the inclination estimator.

8. An information processing method that an information processing device executes, the information processing method comprising:
a bottom determination step of detecting a first timing at which an upper body of a user reaches a lowest position while the user is walking;
a heel touchdown determination step of detecting a second timing at which a heel of the user touches down on a ground while the user is walking;
a time difference calculation step of computing a difference between the first timing and the second timing; and
an inclination estimation step of estimating, on the basis of the difference computed in the time difference calculation step, an angle of inclination of a ground on which the user is walking.
